(19) United States
(12) Patent Application Publication
(10) Pub. No.: US 2025/0229533 A1
(43) Pub. Date: Jul. 17, 2025

(54) ACTUATOR, LIQUID DISCHARGE HEAD, LIQUID DISCHARGE APPARATUS, AND METHOD FOR MANUFACTURING ACTUATOR

(71) Applicant: Tsutoh AOYAMA, Kanagawa (JP)

(72) Inventor: Tsutoh AOYAMA, Kanagawa (JP)

(21) Appl. No.: 18/992,743

(22) PCT Filed: Jun. 26, 2023
(86) PCT No.: PCT/IB2023/056551

§ 371 Date: Jan. 9, 2025

(30) Foreign Application Priority Data
Jul. 22, 2022 (JP) 2022-117508

(51) Int. Cl. B41J 2/14; B41J 2/16

(52) U.S. Cl. CPC B41J 2/14233; B41J 2/161; B41J 2/164; B41J 2002/14241; B41J 2002/14491

(57) ABSTRACT

An actuator includes: a diaphragm on a substrate having a pressure chamber, the diaphragm having a first surface defining a part of a wall of the pressure chamber; a piezoelectric element on a second surface of the diaphragm opposite to the first surface; a lead wire led out from the piezoelectric element to supply electric power to the piezoelectric element; and a moisture-proof film covering: the lead wire; and a part of the piezoelectric element overlapped with the lead wire.

### TECHNICAL FIELD

The present embodiment relates to an actuator, a liquid discharge head, a liquid discharge apparatus, and a method for manufacturing the actuator.

### BACKGROUND ART

Conventionally, there has been known an actuator including a vibrating film, a piezoelectric element, a lead wire, and a moisture-proof film. The vibrating film is formed as a layer on a substrate having a pressure chamber formed therein, and forms part of a wall surface of the pressure chamber. The piezoelectric element is mounted on a surface of the vibrating film opposite to a surface of the vibrating film forming the wall surface of the pressure chamber. The lead wire is led out from the piezoelectric element, and supplies electric power to the piezoelectric element. The moisture-proof film covers the lead wire.

Patent Literature (PTL) 1 describes a liquid discharge head including the above-described actuator. The lead wire of the actuator is covered with an insulating film made of silicon nitride (SiN) having moisture barrier properties, and the entire surface of a driver element as a piezoelectric element is covered with the insulating film described above.

### CITATION LIST

### Patent Literature

### [PTL 1]

Japanese Patent No. 6310824

### SUMMARY OF INVENTION

### Technical Problem

However, there has been a problem that vibration displacement of the piezoelectric element decreases.

### Solution to Problem

An actuator includes: a diaphragm on a substrate having a pressure chamber, the diaphragm having a first surface defining a part of a wall of the pressure chamber; a piezoelectric element on a second surface of the diaphragm opposite to the first surface; a lead wire led out from the piezoelectric element to supply electric power to the piezoelectric element; and a moisture-proof film covering: the lead wire; and a part of the piezoelectric element overlapped with the lead wire.

### Advantageous Effects of Invention

According to the present embodiment, it is possible to prevent a decrease in the vibration displacement of a piezoelectric element.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a schematic cross-sectional view of a nozzle vibration type liquid discharge head in the present embodiment.

FIG. 2 is a schematic perspective view of the liquid discharge head.

FIG. 3 is an enlarged cross-sectional view of a portion X in FIG. 1.

FIG. 4 is a diagram showing an example of a region where a moisture-proof film is formed.

FIG. 5 is a diagram showing another example of the region where the moisture-proof film is formed.

FIG. 6 is a diagram showing still another example of the region where the moisture-proof film is formed.

FIG. 7 is a diagram describing a step of forming a drive circuit, a wiring portion, and a vibrating film on a channel substrate.

FIG. 8 is a diagram describing a step of performing film formation of a first electrode layer, a piezoelectric layer, and a second electrode layer on the vibrating film.

FIG. 9 is a diagram describing a step of forming an insulating film.

FIG. 10 is a diagram describing a step of forming a plurality of contacts.

FIG. 11 is a diagram describing a step of forming lead wires.

FIG. 12 is a diagram describing a step of forming a moisture-proof layer.

FIG. 13 is a diagram describing a step of forming the moisture-proof film on each lead wire and part of a piezoelectric element.

FIG. 14 is a diagram describing a step of performing film formation of a nozzle forming portion.

FIG. 15 is a diagram describing a step of forming a nozzle and a pad opening.

FIG. 16 is a diagram describing a step of forming a pressure chamber.

FIG. 17 is a diagram showing an example in which an electrical connection pad is provided on a side surface of the liquid discharge head.

FIG. 18 is a diagram showing a modification of the liquid discharge head.

FIG. 19 is a diagram showing an example in which an electrical connection pad is provided on a side surface of a liquid discharge head according to a modification.

FIG. 20 is an explanatory diagram schematically illustrating a printer that is an inkjet recording apparatus serving as a liquid discharge apparatus in the present embodiment.

FIG. 21 is an explanatory diagram illustrating a plan view of an example of a head device of the printer of the present embodiment.

FIG. 22 is an explanatory diagram illustrating a plan view of a main part of a printer of another example.

FIG. 23 is an explanatory diagram illustrating a side view of the main part of the printer of another example.

FIG. 24 is an explanatory diagram illustrating a plan view of a main part of a liquid discharge device of another example.

FIG. 25 is an explanatory diagram illustrating a front view of a liquid discharge device of still another example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise.

A description is given below of a liquid discharge head to be installed in a liquid discharge apparatus according to an embodiment of the present disclosure.

The present disclosure is not limited to an embodiment to be described below, but may be another embodiment, and changes such as additions, modifications, and deletions can be made within the scope that can be conceived by those skilled in the art. Any aspect is included in the scope of the present disclosure as long as the function and effect of the present disclosure are achieved.

The liquid discharge head in the present embodiment is a nozzle vibration type liquid discharge head that changes pressure in a pressure chamber by means of an actuator having a nozzle, to discharge liquid in the pressure chamber from the nozzle. The nozzle vibration system is characterized in that droplets can be discharged with a smaller force than a general unimorph piezoelectric head (a liquid discharge head that vibrates a surface of a pressure chamber facing a surface having a nozzle, to discharge liquid). Thus, the nozzle vibration system can achieve power saving of an actuator.

When nozzle density is increased, a space for laying out wires for voltage application is limited. Therefore, it is difficult to perform wiring on a surface of a substrate. When wires and a drive circuit are provided in the substrate, the wires can be laid out even in a configuration with a high nozzle density. In general, lead zirconate titanate (PZT) is widely used as the material of a piezoelectric element because of its high piezoelectric properties. However, PZT needs a temperature of 600° C. or higher for film formation and crystallization. Thus, when PZT is used as the material of a piezoelectric element, a drive circuit and wires thereof in a substrate cannot withstand high temperature. Therefore, it is necessary to use a piezoelectric material having a lower film-formation temperature than PZT. In this case, it is necessary to select a material having lower piezoelectric properties than PZT. However, as described above, the nozzle vibration system is characterized in that droplets can be discharged with a smaller force than a general unimorph piezoelectric head (a liquid discharge head that vibrates a surface of a pressure chamber to discharge liquid, the surface facing a surface having a communication port communicating with a nozzle). Thus, droplets can be satisfactorily discharged even when a material is selected which has lower piezoelectric properties than PZT. Therefore, it is possible to satisfactorily discharge droplets even in the case of using a piezoelectric material having a low film-formation and crystallization temperature but small power, such as a non-lead material. As a result, wires and a drive circuit can be provided in a substrate, and density can be increased.

Furthermore, the volume of a pressure chamber can be reduced in the nozzle vibration system. Thus, a head can be reduced in size.

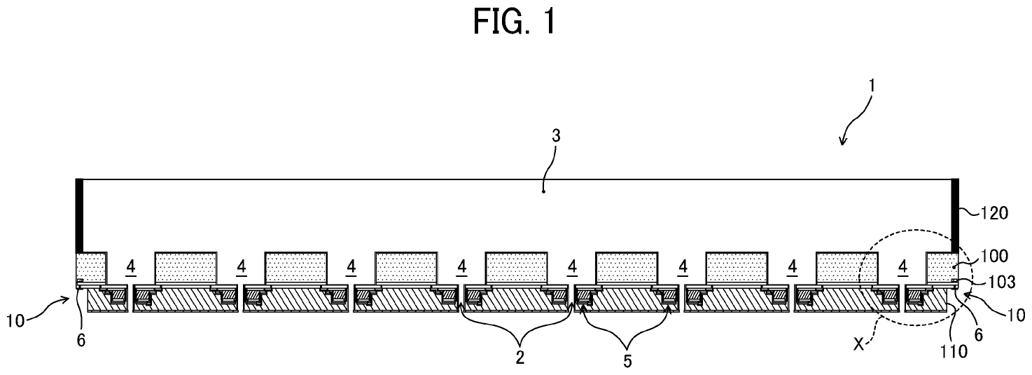

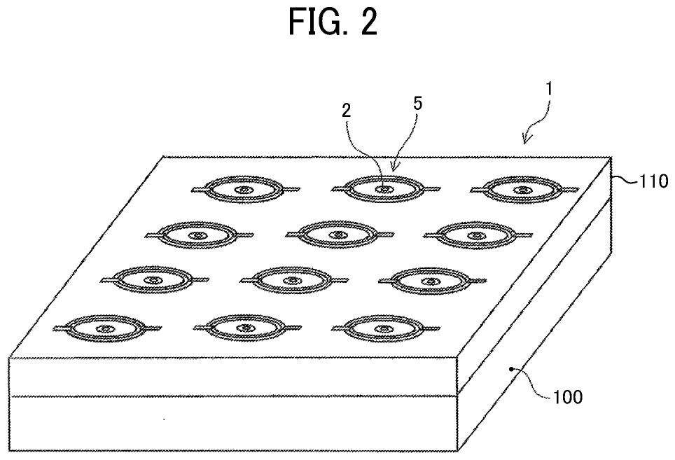

FIG. 1 is a schematic cross-sectional view of a nozzle vibration type liquid discharge head in the present embodiment. FIG. 2 is a schematic perspective view of a liquid discharge head.

A liquid discharge head 1 includes an actuator 110, a channel substrate 100, and a frame member 120.

The actuator 110 is formed as a thin film, and includes a vibrating film 103, a plurality of nozzles 2 and piezoelectric elements 5. The plurality of nozzles 2 discharges liquid. The piezoelectric elements 5 are formed in an annular shape and disposed around the nozzles 2. The channel substrate 100 has a plurality of pressure chambers 4 (also referred to as individual chambers) each communicating with corresponding one of the plurality of nozzles 2. The frame member 120 has a common chamber 3 communicating with the plurality of pressure chambers 4.

An electrical connection pad 6 for connecting to an electrical component such as an external power supply is provided at each end of the liquid discharge head 1.

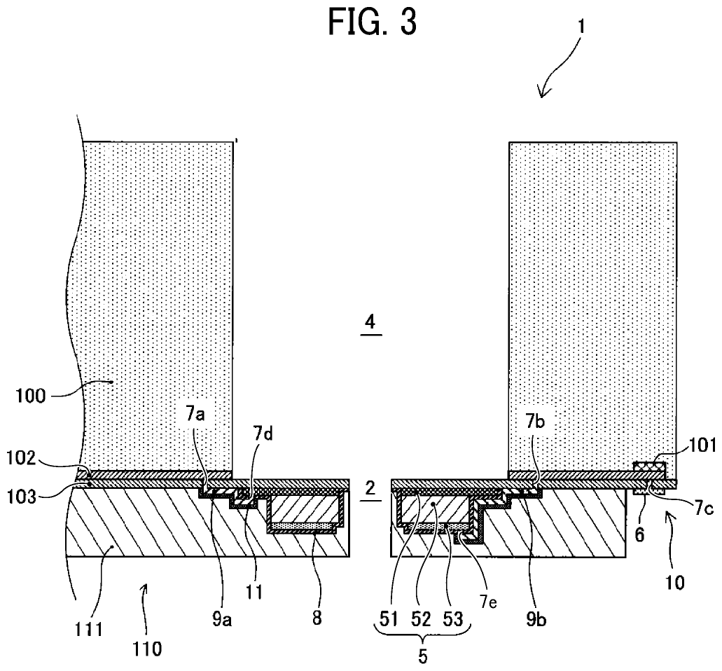

FIG. 3 is an enlarged cross-sectional view of a portion X in FIG. 1.

The channel substrate 100 is a silicon-on-insulator (SOI) substrate, and includes a drive circuit 101 and a wiring portion 102 on a side on which the vibrating film 103 is formed.

The drive circuit 101 is a circuit including a transistor, a resistor, and the like. The wiring portion 102 includes a wiring portion for applying a bias to a first electrode 51 and a wiring portion for applying a bias to a second electrode 53. In addition, the wiring portion 102 is electrically connected to the electrical connection pad 6 via a third contact 7c opened in the vibrating film 103.

The actuator 110 has a nozzle forming portion 111 (nozzle forming film) that covers the piezoelectric elements 5. The nozzle forming portion 111 has the plurality of nozzles 2 formed therein. A liquid-repellent film may be formed on a nozzle surface of the nozzle forming portion 111. Formation of the liquid-repellent film on the nozzle surface makes it possible to prevent liquid from adhering to the nozzle surface. Thus, liquid discharged from the nozzle 2 can be prevented from being affected by liquid having adhered to the nozzle surface. In a case where solvent for the liquid is a water-based solvent, perfluorodecyltrichlorosilane or perfluorooctyltrichlorosilane can be used as material of the liquid-repellent film.

The piezoelectric element 5 of the actuator 110 includes the first electrode 51 (also referred to as a lower electrode), a piezoelectric film 52 (also referred to as a piezoelectric portion), and the second electrode 53 (also referred to as an upper electrode). The piezoelectric element 5 is covered with an insulating film 8.

The insulating film 8 has a hole-shaped fourth contact 7d for electrically connecting to the first electrode 51 and a hole-shaped fifth contact 7e for electrically connecting to the second electrode 53. The fourth contact 7d is referred also as a “first contact”, and the fifth contact 7e is referred also as a “second contact”.

The insulating film 8 has a first lead wire 9a and a second lead wire 9b formed thereon. The first lead wire 9a electrically connects the first electrode of the piezoelectric element and the wiring portion 102 of the channel substrate 100. The second lead wire 9b electrically connects the second electrode 53 of the piezoelectric element and the wiring portion 102 of the channel substrate 100.

The first lead wire 9a is electrically connected to the first electrode 51 via the fourth contact 7d, and electrically connected to the wiring portion 102 via a first contact 7a. The second lead wire 9b is electrically connected to the second electrode 53 via the fifth contact 7e, and electrically connected to the wiring portion 102 via a second contact 7b.

The first lead wire 9a and the second lead wire 9b are covered with a moisture-proof film 11.

This makes it possible to prevent moisture having entered the nozzle forming portion 111 made of resin from entering the first lead wire 9a and the second lead wire 9b. As a result, corrosion of each lead wire can be prevented.

The moisture-proof film 11 preferably has electrical insulation properties. The moisture-proof film 11 has both of insulation properties and moisture barrier properties. As a result, the actuator 110 can be made thinner than in a case where an insulating film is formed under the moisture-proof film 11. As a result, the vibrating film 103 is easily deformed, so that vibration efficiency can be enhanced.

It is desirable to use, as the moisture-proof film 11, silicon nitride (SiN) that is widely used as a moisture-proof film for semiconductors. This is because SiN allows the moisture-proof film 11 to have both of insulation properties and moisture barrier properties. In addition, an oxide of aluminum (Al), tantalum (Ta), niobium (Nb), titanium (Ti), hafnium (Hf), zirconium (Zr), or tungsten (W), which is likely to form a dense film by atomic layer deposition (ALD), can also be used as a material of the moisture-proof film 11.

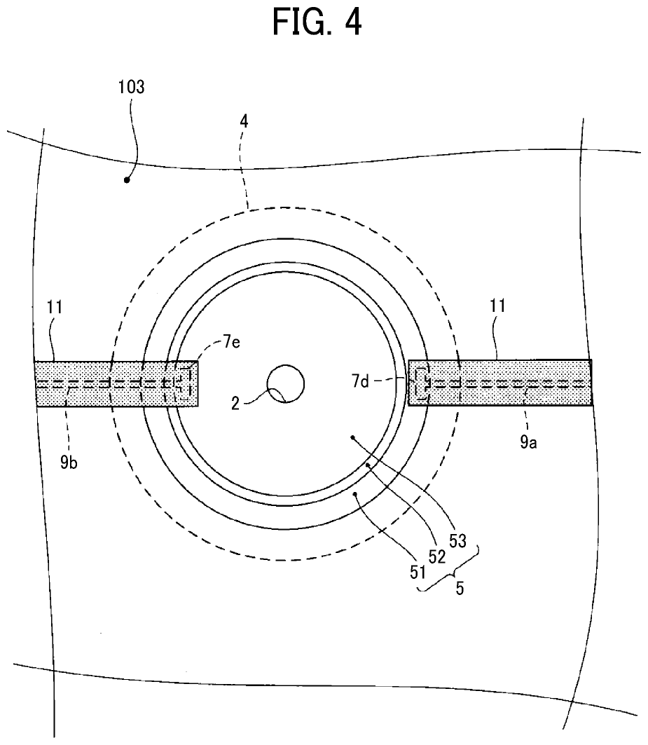

FIG. 4 is a diagram showing an example of a region where the moisture-proof film 11 is formed.

As illustrated in FIG. 4, the moisture-proof film 11 covers the first lead wire 9a, the second lead wire 9b, the fourth contact 7d, the fifth contact 7e, and the peripheries thereof.

Therefore, the piezoelectric element 5 is covered with the moisture-proof film 11 only in the periphery of a portion of the first lead wire 9a overlapping with the piezoelectric element 5, the periphery of a portion of the second lead wire 9b overlapping with the piezoelectric element, the periphery of the fourth contact 7d, and the periphery of the fifth contact 7e.

That is, the piezoelectric element 5 is configured such that its electric circuit is covered with the moisture-proof film 11.

The moisture-proof film 11 is basically a dense and hard film. Therefore, when the entire piezoelectric element is covered with the moisture-proof film 11, rigidity of the piezoelectric element 5 increases, so that vibration displacement decreases. In particular, a piezoelectric material having a low film-formation and crystallization temperature but small power, such as a non-lead material, is used in the present embodiment as described above. Therefore, the effect of a decrease in vibration displacement due to the moisture-proof film 11 is significant.

Therefore, in the present embodiment, the piezoelectric element 5 is just partially covered with the moisture-proof film 11 as illustrated in FIG. 4. Specifically, the piezoelectric element 5 is covered with the moisture-proof film 11 only in the peripheries of the first lead wire 9a, the second lead wire 9b, the fourth contact 7d, and the fifth contact 7e. As a result, as compared with a case where the entire piezoelectric element is covered with the moisture-proof film 11, a decrease in the vibration displacement of the piezoelectric element 5 can be prevented, and the vibrating film 103 can be satisfactorily vibrated.

As described below, the first electrode and the second electrode of the piezoelectric element 5 are made of metal having high corrosion resistance, such as iridium (Ir) or molybdenum (Mo).

Therefore, the first electrode and the second electrode of the piezoelectric element are hardly corroded by moisture having entered the nozzle forming portion 111.

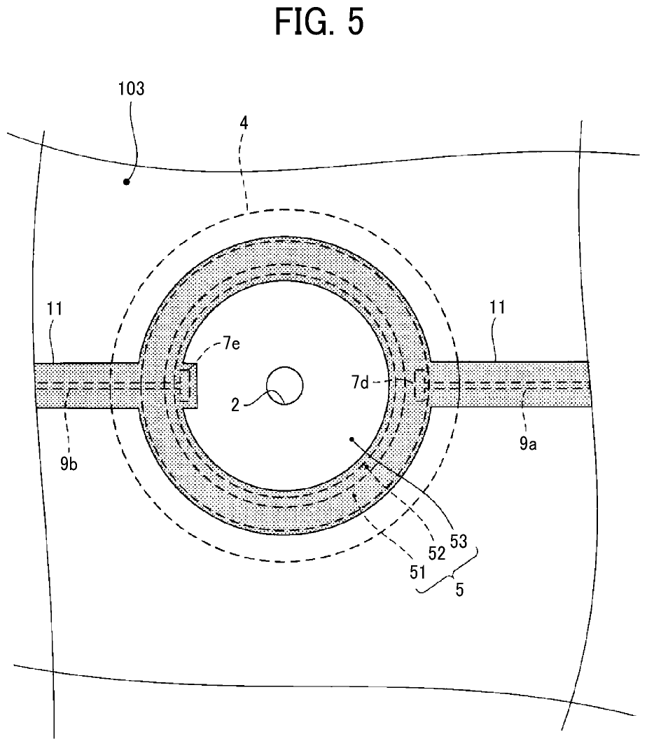

FIG. 5 is a diagram showing another example of the region where the moisture-proof film 11 is formed.

In the example shown in FIG. 5, a portion of the first electrode 51 of the piezoelectric element with no piezoelectric film 52 formed as a layer thereon, a portion of the piezoelectric film 52 with no second electrode 53 formed as a layer thereon, a portion of the second electrode 53 corresponding to the periphery of the fifth contact 7e, and the edge of the second electrode 53 are covered with the moisture-proof film 11. That is, the moisture-proof film 11 annularly covers a region between the fourth contact 7d and the fifth contact 7e in a region where the piezoelectric element is provided around the nozzle.

In the piezoelectric element 5, the portion of the first electrode 51 with no piezoelectric film 52 formed as a layer thereon and the portion of the piezoelectric film 52 with no second electrode 53 formed as a layer thereon are hardly displaced at the time of driving. Therefore, even if the portion of the first electrode 51 of the piezoelectric element 5 with no piezoelectric film 52 formed as a layer thereon and the portion of the piezoelectric film 52 with no second electrode 53 formed as a layer thereon are covered with the moisture-proof film 11, as illustrated in FIG. 5, to increase the rigidity of these portions, the vibration displacement of the piezoelectric element 5 hardly decreases. Therefore, even when only the second electrode 53 is partially covered with the moisture-proof film 11 as illustrated in FIG. 5, a decrease in the vibration displacement of the piezoelectric element 5 can be prevented, and the vibrating film 103 can be satisfactorily vibrated.

In FIG. 5, the moisture-proof film 11 annularly covers an area extending from the fourth contact 7d to the edge of the second electrode 53, and protrudes toward a nozzle side (inner side) to cover the fifth contact 7e located closer to the nozzle than the edge of the second electrode 53. Thus, there is a possibility that a load on the vibration of the piezoelectric element will not be uniform. Therefore, a portion of the piezoelectric element 5 corresponding to the region between the fourth contact 7d and the fifth contact 7e may be annularly covered with the moisture-proof film 11 such that the moisture-proof film 11 covering the piezoelectric element has no portion protruding toward the nozzle side. As a result, the piezoelectric element 5 is uniformly covered with the moisture-proof film 11 around the nozzle 2, and the load on vibration due to the moisture-proof film 11 can be made uniform.

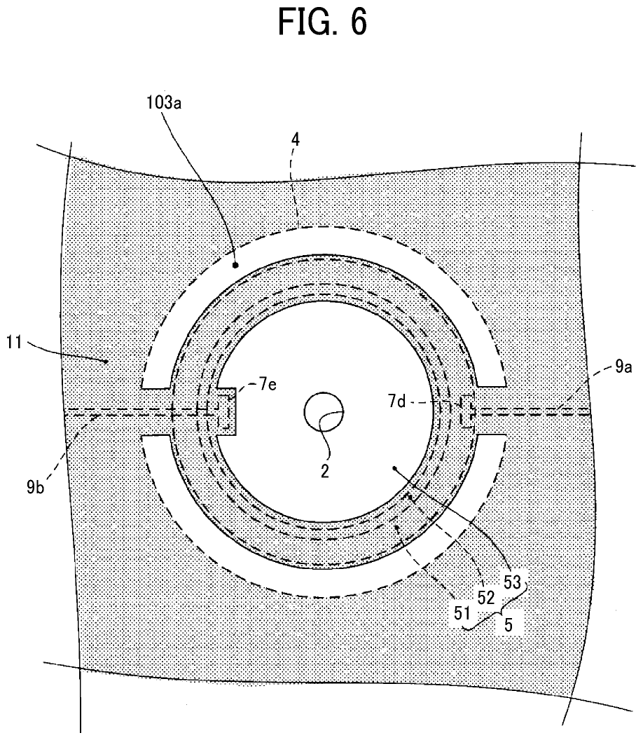

FIG. 6 is a diagram showing still another example of the region where the moisture-proof film 11 is formed.

In the example shown in FIG. 6, the vibrating film 103 is covered with the moisture-proof film 11, except for a vibration region 103a. The vibration region 103a of the vibrating film 103 is a portion of the vibrating film 103 forming a bottom surface of the pressure chamber 4.

The vibration region 103a described above is covered with the moisture-proof film 11 only in the peripheries of the first lead wire 9a and the second lead wire 9b crossing the vibration region. As described above, the vibration region 103a of the vibrating film 103 is just partially covered with the moisture-proof film 11 (only in the peripheries of the first lead wire 9a and the second lead wire 9b are covered with the moisture-proof film 11). Therefore, the Young's modulus of the vibration region 103a can be reduced as compared with a configuration in which the entire vibration region 103a is covered with the moisture-proof film 11. As a result, the vibration region 103a can be easily vibrated by displacement of the piezoelectric element 5. Thus, vibration efficiency can be enhanced as compared with the configuration in which the entire vibration region 103a is covered with the moisture-proof film 11.

Also in the configuration illustrated in FIG. 6, the portion of the piezoelectric element 5 corresponding to the region between the fourth contact 7d and the fifth contact 7e may be annularly covered with the moisture-proof film 11 so as to achieve a uniform load on vibration due to the moisture-proof film 11.

Each of the first electrode 51 and the second electrode 53 may be provided with a lead wire portion so as to allow the first electrode 51 and the second electrode 53 to be electrically connected to the wiring portion 102 directly via a contact opened in the vibrating film.

In addition, an adhesion improving film for ensuring adhesion to the nozzle forming portion 111 may be formed on the moisture-proof film 11.

Furthermore, in a case where inner peripheral surfaces of the pressure chamber 4 and the nozzle 2 are eroded by the liquid, a protective film resistant to the liquid may be provided on the inner peripheral surfaces of the pressure chamber 4 and the nozzle 2. Examples of the protective film include metallic oxide that achieves a passive state. Examples of the metal of the metallic oxide include tantalum (Ta), niobium (Nb), titanium (Ti), zirconium (Zr), hafnium (Hf), and tungsten (W) that can be flexibly applied in terms of oxidation numbers.

In particular, it is desirable to use Zr or Hf having a valence similar to the valence of silicon dioxide (SiO₂), or use Ta having a valence close to the valence of Zr or Hf.

In addition, it is desirable for the protective film to be lyophilic. In a case where a lyophilic protective film is used, liquid easily spreads on the inner peripheral surfaces of the pressure chamber 4 and the nozzle 2 to wet the inner peripheral surfaces of the pressure chamber 4 and the nozzle 2 at the time of filling the pressure chamber 4 with the liquid. As a result, the filling property of liquid can be improved. In a case where solvent for the liquid is a water-based solvent, it is possible to use a mixture in which a metallic oxide is mixed with silicon dioxide (SiO₂) at the molecular level. Replacing O of SiO₂ on the surface of the protective film with a hydrophilic OH group enables the protective film to have hydrophilicity.

Liquid with which the liquid discharge head is filled enters the nozzle 2, and forms a meniscus in the nozzle. When a predetermined drive waveform (voltage) is applied to each electrode of the piezoelectric element 5, the piezoelectric film 52 vibrates, and the vibrating film 103 vibrates in an up-and-down direction in FIG. 3. Vibration of the vibrating film 103 causes a change in the pressure of liquid in the pressure chamber. As a result, the liquid is discharged from the nozzle 2.

Next, a method for manufacturing the liquid discharge head according to the present embodiment will be described.

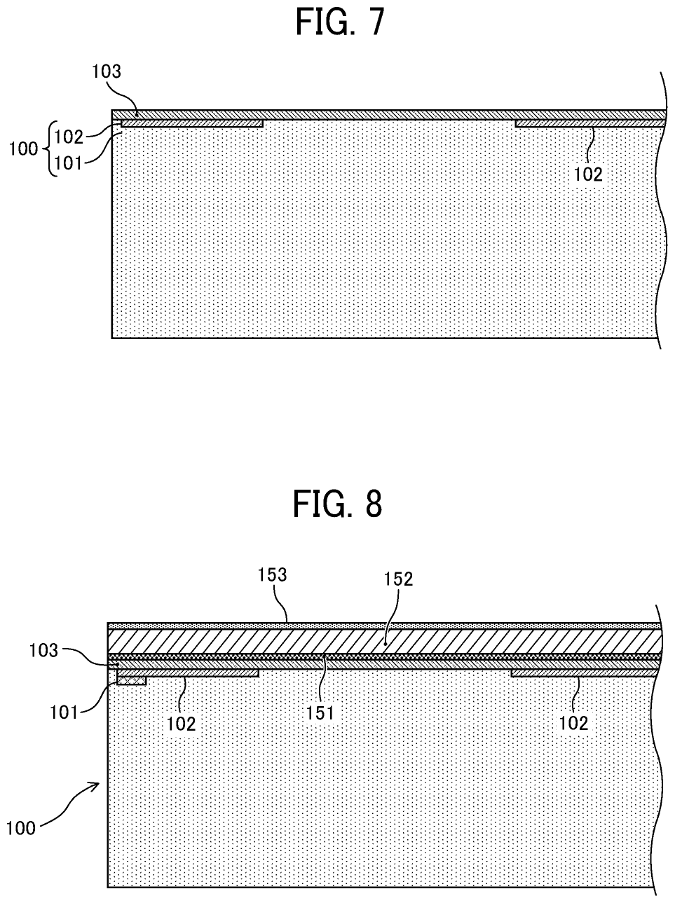

FIGS. 7 to 16 are diagrams for describing a process of manufacturing the liquid discharge head of the present embodiment, which are cross-sectional views of the liquid discharge head taken along a line orthogonal to a direction in which the nozzles 2 are arranged.

First, as illustrated in FIG. 7, the drive circuit 101 and the wiring portion 102 are formed on a silicon film of the channel substrate 100 as a silicon-on-insulator (SOI) substrate. The drive circuit 101 includes a transistor, a resistor, and the like. In a case where the drive circuit 101 described above is not built into the channel substrate 100, an Si substrate may be used as the channel substrate 100.

Next, the vibrating film 103 is formed on a surface of the channel substrate 100 on which the drive circuit 101 and the wiring portion 102 have been formed. The vibrating film 103 may be made of SiO₂, SiN, metallic oxide, resin, or any other material as long as the material has at least insulation properties. However, in order to increase displacement, it is desirable to use a material having a low Young's modulus. In addition, considering a difference in a coefficient of linear expansion from the channel substrate 100, it is most desirable to use, as the material of the vibrating film 103, silicon dioxide (SiO₂) having a relatively small difference.

Next, as illustrated in FIG. 8, a first electrode layer 151, a piezoelectric layer 152, and a second electrode layer 153 are formed as films on the vibrating film 103. The first electrode layer 151 and the second electrode layer 153 are desirably made of metal having low electric resistance and low reactivity, such as Ir or Mo.

In a case where the drive circuit 101 and the wiring portion 102 are built into the channel substrate 100 so as to improve density as in the present embodiment, it is desirable to use, as a piezoelectric material for the piezoelectric layer 152, a piezoelectric material having a film-formation temperature of 450° C. or lower so as not to damage the drive circuit 101 and the wiring portion 102. Examples of the piezoelectric material having a film-formation temperature of 450° C. or lower include aluminum nitride (AlN).

Furthermore, it is also possible to obtain the following advantages by using AlN as the piezoelectric material. That is, it is possible to improve piezoelectric properties by making the crystalline orientation of the piezoelectric film 52 uniform. Therefore, it is necessary to provide an orientation control layer between the vibrating film 103 and the first electrode 51 so as to control the orientation. When AlN is used as the piezoelectric material of the piezoelectric film 52, it is possible to make the lattice constant of the first electrode 51 made of Mo close to AlN by using AlN also as the orientation control layer. As a result, the crystalline orientation of the piezoelectric film 52 becomes uniform, so that piezoelectric properties can be improved.

In general, a sputtering method is used for film formation of the first electrode layer 151 and the second electrode layer 153. Examples of a method for performing film formation of the piezoelectric layer 152 include the sputtering method and a sol-gel method. However, since film-formation temperature is high in the sol-gel method, the sol-gel method is not suitable for film formation on the channel substrate 100 including the drive circuit 101 and the wiring portion 102. Therefore, film formation of the piezoelectric layer 152 is also desirably performed by use of the sputtering method.

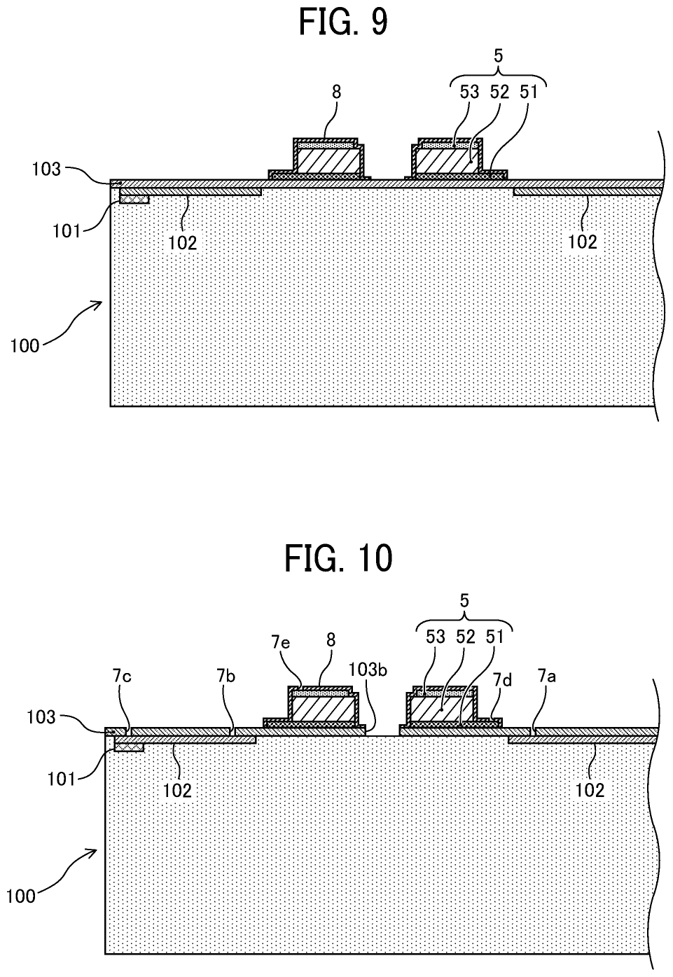

After film formation of the first electrode layer 151, the piezoelectric layer 152, and the second electrode layer 153 is performed, the first electrode layer 151, the piezoelectric layer 152, and the second electrode layer 153 are each formed in an appropriate shape to obtain the piezoelectric element 5 including the first electrode 51, the piezoelectric film 52, and the second electrode 53, as illustrated in FIG. 9. The first electrode layer 151, the piezoelectric layer 152, and the second electrode layer 153 are processed by photolithography and etching.

As a result, it is possible to easily obtain the first electrode 51, the piezoelectric film 52, and the second electrode 53 each having a desired shape. Etching includes wet etching and dry etching. Dry etching can prevent corrosion of the first electrodes 51, the second electrode 53, and the piezoelectric film 52. Therefore, it is desirable to use dry etching. Residue resulting from the processing tends to remain after dry etching. Therefore, after shaping is performed, a cleaning step may be performed so as to remove residue.

After the shaping of the first electrode 51, the piezoelectric film 52, and the second electrode 53 is performed, the insulating film 8 is formed and shaped by etching as illustrated in FIG. 9.

As with the vibrating film 103, the insulating film 8 desirably has insulation properties, a small Young's modulus, and a coefficient of linear expansion close to the coefficient of linear expansion of constituent material. Therefore, it is desirable to use SiO₂ as with the vibrating film 103.

After the insulating film 8 is formed, the first to fifth contacts 7a to 7e, which are hole-shaped contacts, are formed in the vibrating film 103 and the insulating film 8 by photolithography and etching as illustrated in FIG. 10. In addition to the first to third contacts 7a to 7c, a nozzle forming hole 103b for forming the nozzle 2 is also formed in the vibrating film 103.

Formation of the nozzle forming hole 103b is preferably performed together with formation of the first to third contacts 7a to 7c so as to facilitate subsequent processing.

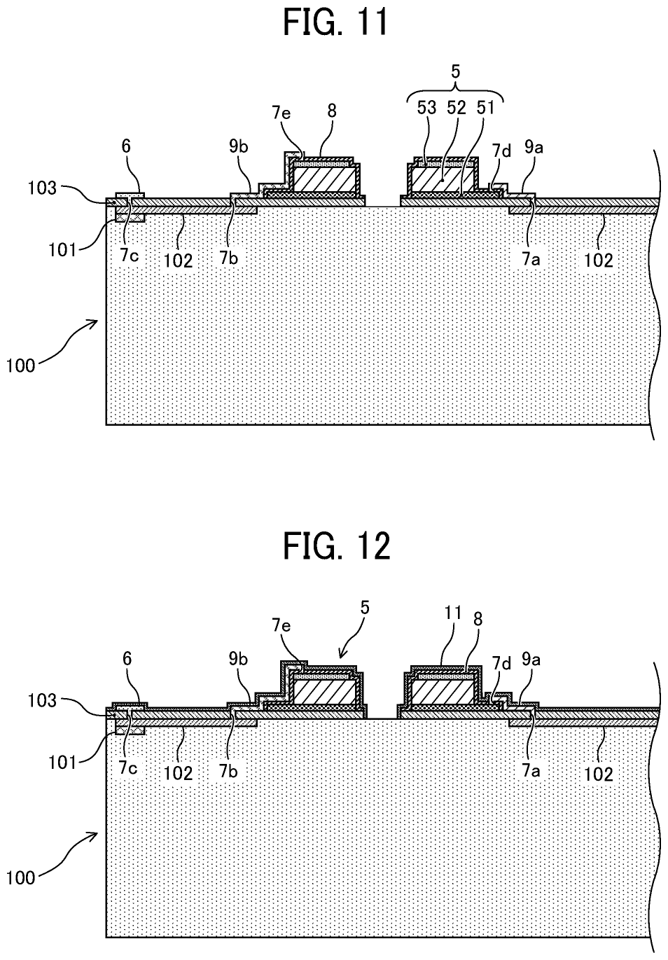

Next, the first lead wire 9a, the second lead wire 9b, and the electrical connection pad 6 are formed as illustrated in FIG. 11. In general, Al or an AlCu alloy is used as the material of each of the lead wires 9a and 9b and the electrical connection pad 6. As a result of this step, the first lead wire 9a is electrically connected to the first electrode 51 via the fourth contact 7d, and is electrically connected to the wiring portion 102 via the first contact 7a. In addition, the second lead wire 9b is electrically connected to the second electrode 53 via the fifth contact 7e, and is electrically connected to the wiring portion 102 via the second contact 7b. Furthermore, the electrical connection pad 6 is electrically connected via the third contact 7c.

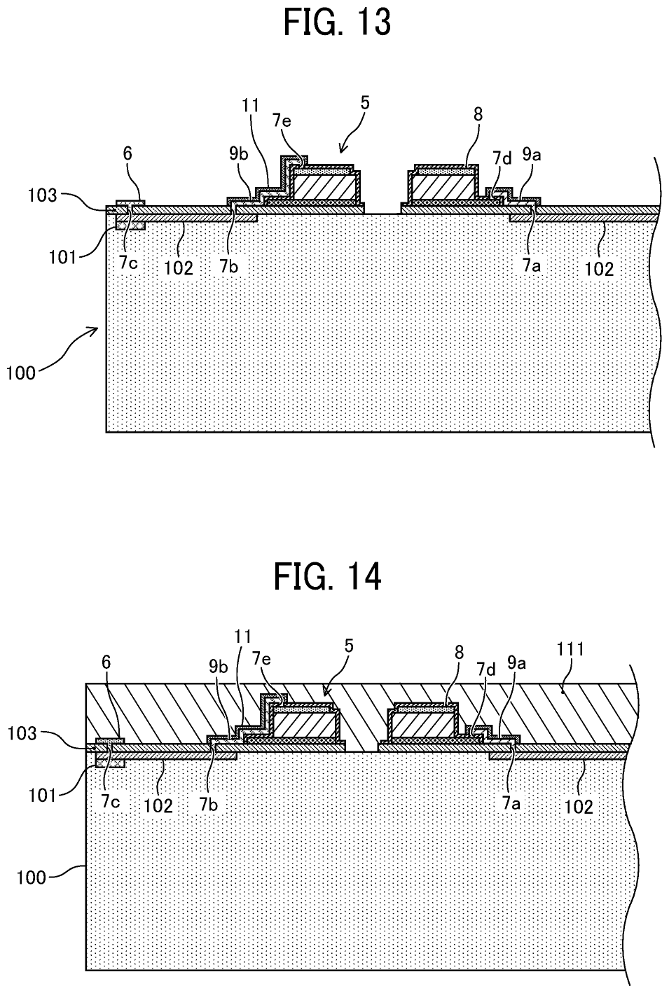

Next, the moisture-proof film 11 is formed as illustrated in FIG. 12 and then processed by photolithography and etching to form the moisture-proof film 11 covering the first lead wire 9a, the second lead wire 9b, the fourth contact 7d, and the fifth contact 7e as illustrated in FIG. 13.

As a result of the above steps, the piezoelectric element 5 can be driven.

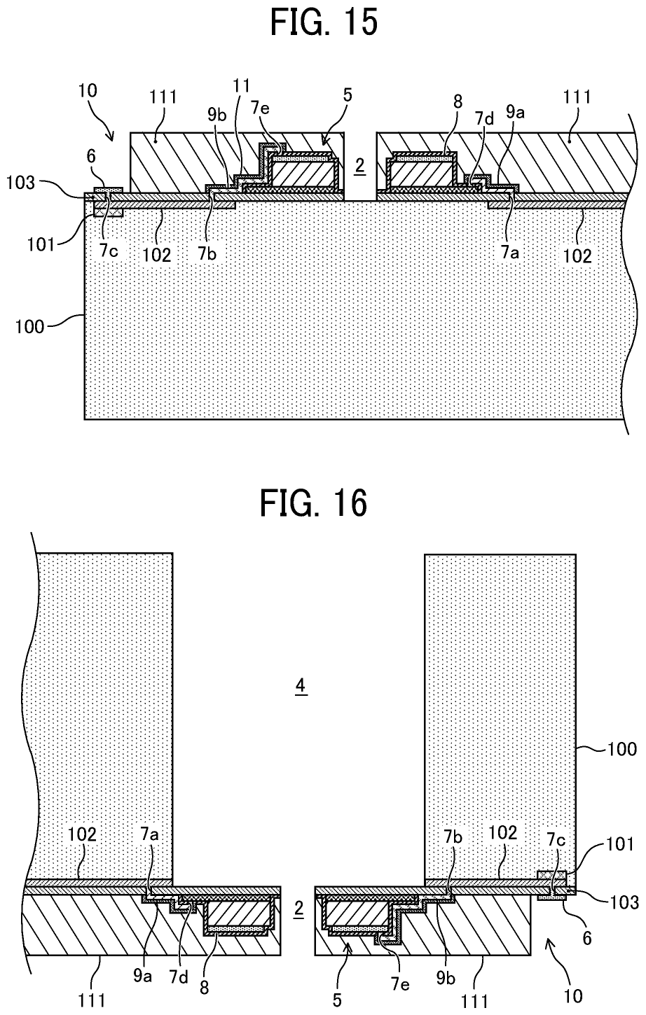

Next, film formation of the nozzle forming portion 111 for nozzle formation is performed as illustrated in FIG. 14. Film formation of the nozzle forming portion 111 is performed by spin coating. It is desirable to use, as the material of the nozzle forming portion 111, resin that can be applied by spin coating. From the viewpoint of chemical resistance, it is desirable to use SU-8, benzocyclobutene (BCB), or the like. Then, as illustrated in FIG. 15, the nozzle 2 and a pad opening 10 are formed by etching. The nozzle 2 and the pad opening 10 are formed by dry etching.

Next, as illustrated in FIG. 16, the channel substrate 100 is processed by Si etching to form a plurality of the pressure chambers 4 each having a circular hole shape. It is necessary to increase the aspect ratio of the cross section of the pressure chamber 4 so as to increase discharge efficiency and reduce crosstalk (make the pressure chamber deep relative to the diameter of the pressure chamber). Therefore, in the present embodiment, the pressure chamber 4 is formed by deep reactive ion etching (DRIE). In DRIE, a CF-based gas such as CF4 or C4F8, or an SF-based gas such as SF6 is used as etching gas.

Thereafter, the frame member 120 in which the common chamber 3 has been formed is joined to the back surface of the channel substrate 100 to form the liquid discharge head 1.

In the nozzle vibration type liquid discharge head, accuracy of the positional relationship between the channel substrate 100 and the actuator 110 having nozzles greatly affects discharge characteristics. Therefore, it is necessary to ensure high dimensional accuracy at the time of manufacturing. Therefore, in a case where the actuator 110 having the nozzles is joined to the channel substrate 100 having the pressure chambers 4 to form the liquid discharge head, it is necessary to perform a highly accurate joining process. In contrast, in the present embodiment, films of materials forming the actuator 110 are sequentially formed on the channel substrate 100, and predetermined processing is performed. As a result, the actuator 110 is formed directly on the channel substrate 100. This eliminates the need for the highly accurate joining process, and enables the liquid discharge head to be easily formed.

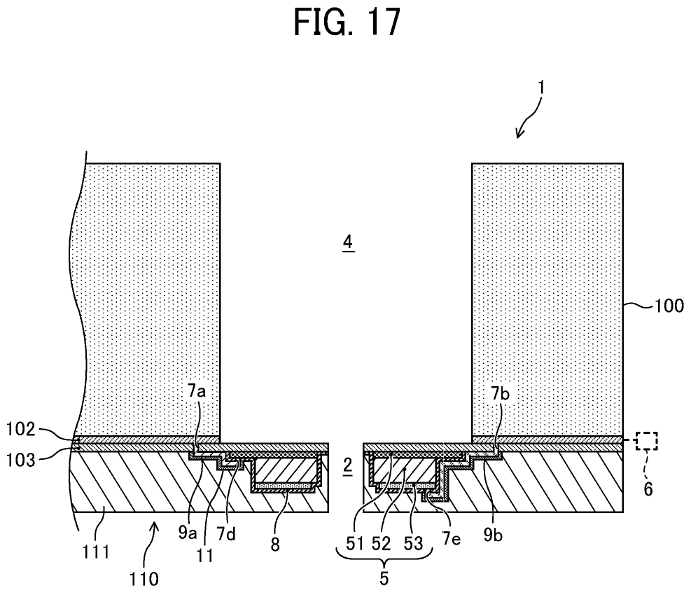

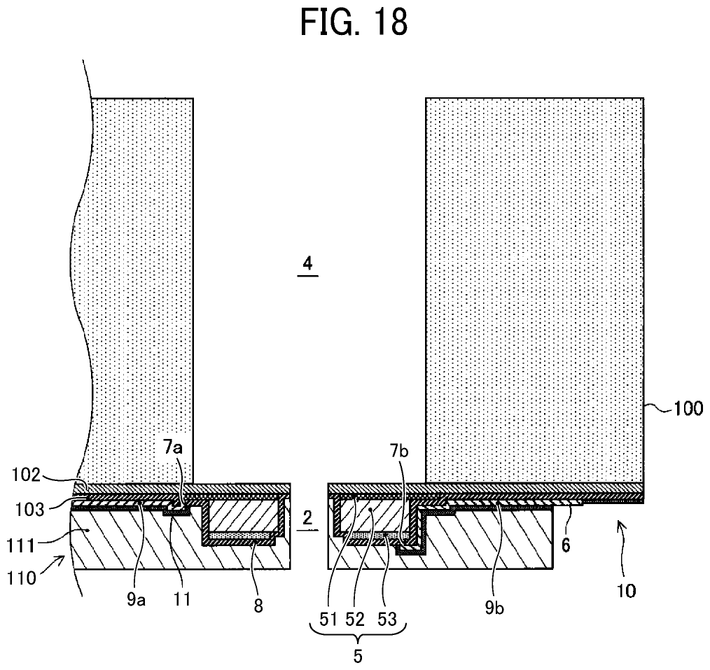

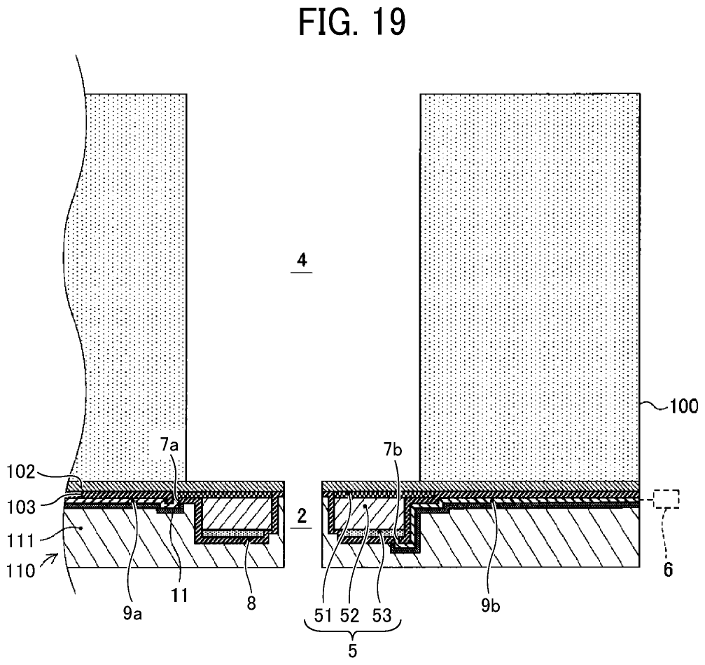

As illustrated in FIG. 17, the wiring portion 102 of the channel substrate 100 may be extended to an end of a side surface of the liquid discharge head 1 so as to allow an end of the wiring portion 102 to be electrically connected to the electrical connection pad 6 for connecting to an electrical component such as an external power supply. In addition, as illustrated in FIGS. 18 and 19, the channel substrate 100 may be configured such that the channel substrate 100 includes no wiring portion 102 or drive circuit 101. FIG. 18 shows an example in which one end of each of the first lead wire 9a and the second lead wire 9b is exposed to the outside to form the electrical connection pad 6. FIG. 19 shows an example in which a lead wire is extended to the end of the side surface of the liquid discharge head 1 to electrically connect an end of the lead wire to the electrical connection pad 6.

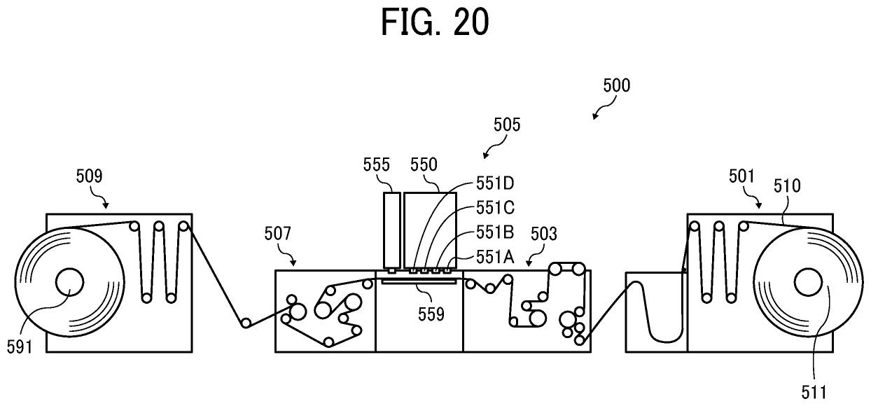

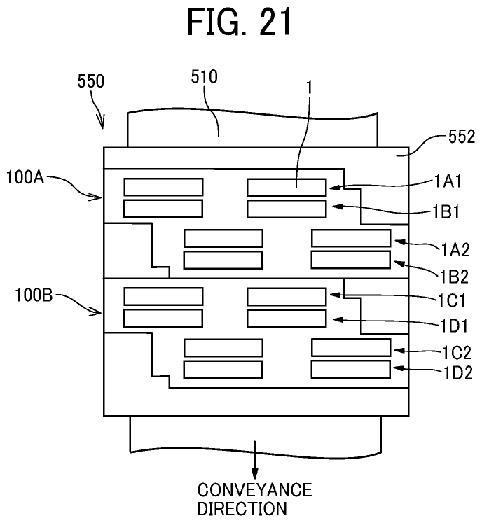

Next, an example of the liquid discharge apparatus according to the present embodiment will be described with reference to FIGS. 20 and 21.

FIG. 20 is an explanatory diagram schematically illustrating a printer that is an inkjet recording apparatus serving as the liquid discharge apparatus in the present embodiment.

FIG. 21 is an explanatory diagram illustrating a plan view of an example of a head device of the printer of the present embodiment.

A printer 500 serving as the liquid discharge apparatus includes a feeder 501 and a guide conveyor 503. The feeder 501 carries in a continuous medium 510. The guide conveyor 503 guides and conveys the continuous medium 510 carried in by the feeder 501 to a printing unit 505. The printer 500 also includes the printing unit 505, a dryer 507, an ejector 509, and the like. The printing unit 505 performs printing by discharging liquid onto the continuous medium 510 to form an image. The dryer 507 dries the continuous medium 510.

The ejector 509 ejects the continuous medium 510.

The continuous medium 510 is fed from a winding roller 511 of the feeder 501, guided and conveyed with rollers of the feeder 501, the guide conveyor 503, the dryer 507, and the ejector 509, and wound around a take-up roller 591 of the ejector 509. In the printing unit 505, the continuous medium 510 is conveyed on a conveyance guide 559 in such a way as to face a head device 550. An image is formed on the continuous medium 510 by liquid discharged from the head device 550.

In the printer 500 of the present embodiment, a common base member 552 in the head device 550 includes two head modules 100A and 100B according to the present embodiment described above.

When an arrangement direction of the liquid discharge heads 1 of the head modules 100A and 100B in a direction orthogonal to a conveyance direction is defined as a head arrangement direction, head arrays 1A1 and 1A2 of the head module 100A discharge liquid of the same color. Similarly, head arrays 1B1 and 1B2 of the head module 100A are grouped as one set, and discharge liquid of the same desired color. Head arrays 1C1 and 1C2 of the head module 100B are grouped as one set, and discharge liquid of the same desired color. Head arrays 1D1 and 1D2 of the head module 100B are grouped as one set, and discharge liquid of the same desired color.

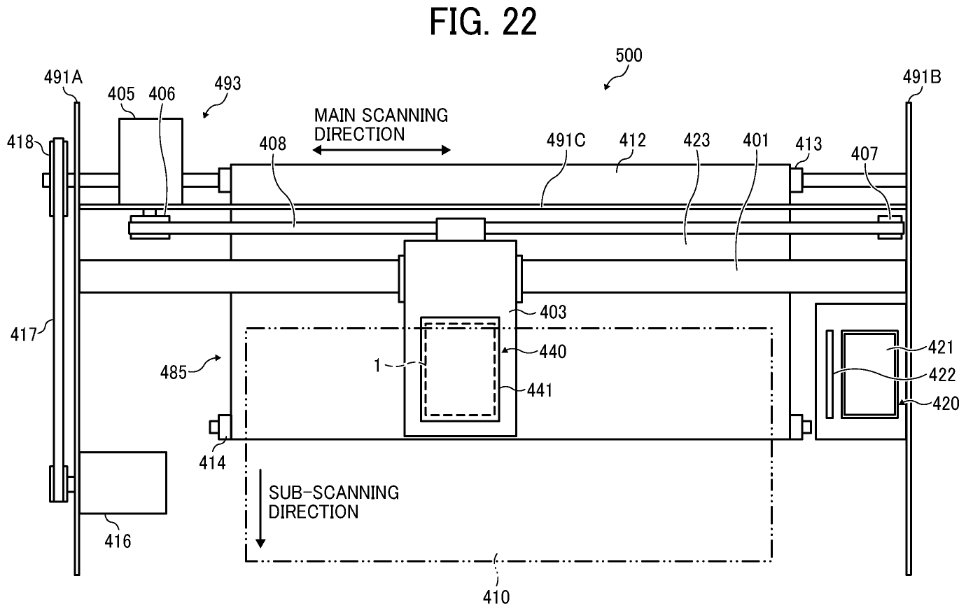

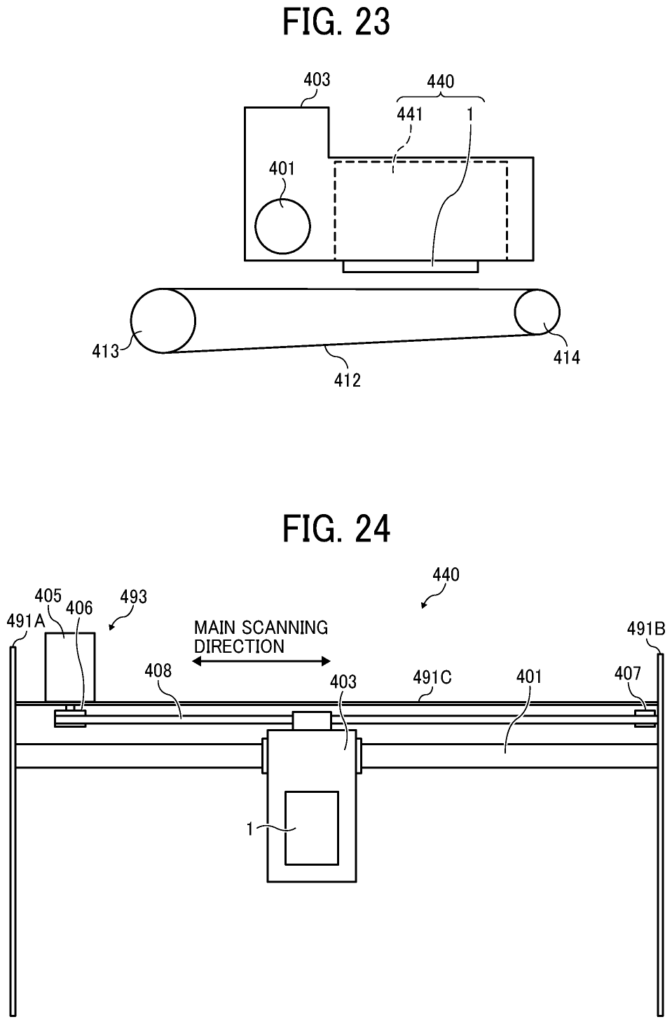

Next, another example of the printer serving as the liquid discharge apparatus according to the present embodiment will be described with reference to FIGS. 22 and 23.

FIG. 22 is an explanatory diagram illustrating a plan view of a main part of a printer of the present example FIG. 23 is an explanatory diagram illustrating a side view of the main part of the printer of the present example.

The printer 500 of the present example is a serial head apparatus. In the printer 500, a main scan moving unit 493 causes a carriage 403 to reciprocate in a main-scanning direction. The main scan moving unit 493 includes a guide 401, a main scan motor 405, a timing belt 408, and the like. The guide 401 is bridged between a left-side plate 491A and a right-side plate 491B to moveably hold the carriage 403. The main scan motor 405 reciprocally moves the carriage 403 in the main-scanning direction via the timing belt 408 bridged between a drive pulley 406 and a driven pulley 407.

The carriage 403 is equipped with a liquid discharge device 440 in which the liquid discharge head 1 according to the present embodiment and a head tank 441 are integrated. The liquid discharge head 1 discharges liquid of each color of, for example, yellow (Y), cyan (C), magenta (M), and black (K). The liquid discharge head 1 includes a nozzle array including multiple nozzles arrayed in a sub-scanning direction orthogonal to the main-scanning direction. The liquid discharge head 1 is mounted on the carriage 403 in such a way as to discharge liquid downward. The liquid discharge head 1 is connected to a liquid circulation apparatus. Thus, liquid of a desired color is circulated and supplied.

The printer 500 includes a conveyor 495 that conveys a sheet 410. The conveyor 495 includes a conveyance belt 412 as a conveyor, and a sub scan motor 416 that drives the conveyance belt 412. The conveyance belt 412 attracts the sheet 410, and conveys the sheet 410 to a position where the sheet 410 faces the liquid discharge head 1. The conveyance belt 412 is an endless belt stretched between a conveyance roller 413 and a tension roller 414.

Attraction of the sheet 410 to the conveyance belt 412 may be applied by electrostatic adsorption, air suction, or the like. The conveyance belt 412 rotates in the sub-scanning direction as the conveyance roller 413 is rotationally driven by the sub scan motor 416 via a timing belt 417 and a timing pulley 418.

A maintenance unit 420 is disposed on one side of the carriage 403 in the main-scanning direction and on a lateral side of the conveyance belt 412. The maintenance unit 420 maintains the liquid discharge head 1 in good condition. The maintenance unit 420 includes, for example, a cap 421 and a wiper 422. The cap 421 caps the nozzle surface of the liquid discharge head 1. The wiper 422 wipes the nozzle surface. The main scan moving unit 493, the maintenance unit 420, and the conveyor 495 are mounted in a housing including the side plates 491A and 491B and a back plate 491C.

In the printer 500 configured as described above, the sheet 410 is fed onto and attracted by the conveyance belt 412, and is conveyed in the sub-scanning direction by rotation of the conveyance belt 412. The liquid discharge head 1 is driven in response to image signals while the carriage 403 is being moved in the main-scanning direction. As a result, liquid is discharged to the sheet 410 at rest, to form an image on the sheet 410.

Next, another example of the liquid discharge device according to the present embodiment will be described with reference to FIG. 24.

FIG. 24 an explanatory diagram illustrating a plan view of a main part of a liquid discharge device of the present example.

The liquid discharge device 440 includes a housing portion, the main scan moving unit 493, the carriage 403, and the liquid discharge head 1 among the members included in the liquid discharge apparatus described above. The housing portion includes the side plates 491A and 491B and the back plate 491C.

Note that, in the liquid discharge device 440, the maintenance unit 420 described above may be mounted on the right-side plate 491B, for example.

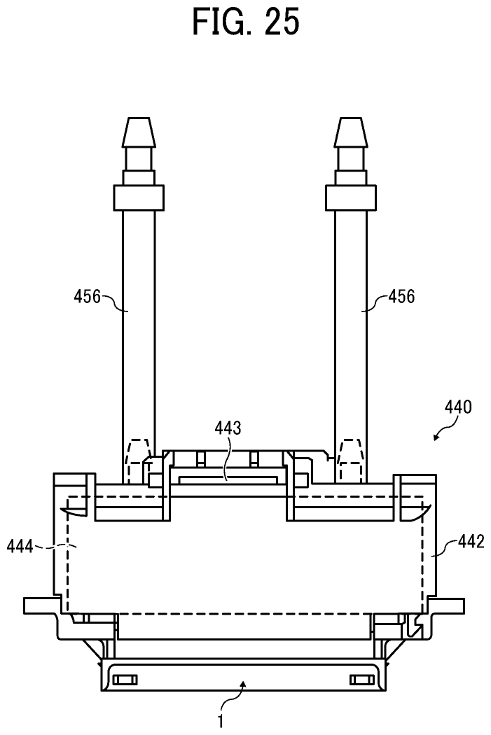

Next, still another example of the liquid discharge device according to the present embodiment will be described with reference to FIG. 25.

FIG. 25 is an explanatory diagram illustrating a front view of a liquid discharge device of the present example.

The liquid discharge device 440 includes the liquid discharge head 1 to which a channel part 444 has been attached, and tubes 456 connected to the channel part 444.

The channel part 444 is disposed inside a cover 442. Instead of the channel part 444, the liquid discharge device 440 may include the head tank 441. A connector 443 for electrical connection with the liquid discharge head 1 is provided above the channel part 444.

In the present embodiment, liquid to be discharged is not limited to a particular liquid as long as the liquid has viscosity or surface tension that allows the liquid to be discharged from a head (liquid discharge head). However, preferably, the viscosity of the liquid is not greater than 30 mPa·s under ordinary temperature and ordinary pressure or when heated or cooled.

Examples of the liquid include a solution, a suspension, and an emulsion that contain, for example, a solvent, such as water or an organic solvent, a colorant, such as dye or pigment, a functional material, such as a polymerizable compound, a resin, or a surfactant, a biocompatible material, such as DNA, amino acid, protein, or calcium, or an edible material, such as a natural colorant. Such a solution, a suspension, or an emulsion can be used for, e.g., inkjet ink, surface treatment solution, a liquid for forming components of electronic element or light-emitting element or for forming a resist pattern of electronic circuit, or a material solution for three-dimensional fabrication.

Examples of an energy source that generates energy for discharging liquid include a piezoelectric actuator (a laminated piezoelectric element or a thin-film piezoelectric element), a thermal actuator that employs a thermoelectric conversion element, such as a heating resistor, and an electrostatic actuator including a diaphragm and counter electrodes.

The “liquid discharge device” is an assembly of parts relating to liquid discharge. The term “liquid discharge device” represents a structure including the liquid discharge head and a functional part(s) or unit(s) combined with the liquid discharge head to form a single unit.

For example, the “liquid discharge device” includes a combination of the liquid discharge head with at least one of a head tank, a carriage, a supply unit, a maintenance unit, a main scan moving unit, or a liquid circulation apparatus.

Examples of the “single unit” include a combination in which the liquid discharge head and one or more functional parts and units are secured to each other through, e.g., fastening, bonding, or engaging, and a combination in which one of the liquid discharge head and the functional parts and units is movably held by another. The liquid discharge head and the functional part(s) or unit(s) may be detachably attached to each other.

For example, the liquid discharge head and the head tank may form the liquid discharge device as a single unit. Alternatively, the liquid discharge head and the head tank coupled (connected) with a tube or the like may form the liquid discharge device as a single unit. A unit including a filter may be added at a position between the head tank and the liquid discharge head of the liquid discharge device.

In another example, the liquid discharge head and the carriage may form the liquid discharge device as a single unit.

In still another example, the liquid discharge device includes the liquid discharge head movably held by a guide that forms part of a main scan moving unit, so that the liquid discharge head and the main scan moving unit form a single unit. The liquid discharge device may include the liquid discharge head, the carriage, and the main scan moving unit that form a single unit.

In still another example, a cap that forms part of the maintenance unit may be secured to the carriage with the liquid discharge head mounted thereon so that the liquid discharge head, the carriage, and the maintenance unit form a single unit to form the liquid discharge device.

Furthermore, in still another example, the liquid discharge device includes a tube connected to the head tank or the liquid discharge head with a channel part mounted thereon, so that the liquid discharge head and the supply unit form a single unit. A liquid in a liquid reservoir source such as an ink cartridge is supplied to the liquid discharge head through this tube.

The main scan moving unit may be a guide only. The supply unit may be a tube(s) only or a loading unit only.

The “liquid discharge device” includes a head module including the above-described liquid discharge head, and a head device in which the above-described functional parts and mechanisms are combined to form a single unit.

The term “liquid discharge apparatus” used herein also represents an apparatus that includes the liquid discharge head, the liquid discharge device, the head module, and the head device, and discharges liquid by driving the liquid discharge head. The liquid discharge apparatus may be, for example, an apparatus that can discharge liquid to a material to which liquid can adhere, or an apparatus that discharges liquid toward gas or into liquid.

The liquid discharge apparatus may include devices that feed, convey, and eject the material to which liquid can adhere. The liquid discharge apparatus may further include a pretreatment apparatus and a post-treatment apparatus that coat, with a treatment liquid, the material onto which the liquid has been discharged.

The “liquid discharge apparatus” may be, for example, an image forming apparatus that forms an image on a sheet by discharging ink, or a three-dimensional fabrication apparatus that discharges a fabrication liquid to a powder layer in which powder material is formed in layers, to form a three-dimensional fabrication object.

The liquid discharge apparatus is not limited to an apparatus that discharges liquid to visualize meaningful images, such as letters or figures. For example, the liquid discharge apparatus may be an apparatus that forms meaningless images, such as meaningless patterns, or fabricates three-dimensional images.

The above-described term “material to which liquid can adhere” represents a material to which liquid at least temporarily adheres, a material to which liquid adheres and is fixed, or a material into which liquid permeates after adhering thereto. Examples of the “material to which liquid can adhere” include recording media, such as a paper sheet, recording paper, a recording sheet of paper, a film, and cloth, electronic components, such as an electronic substrate and a piezoelectric element, and media, such as a powder layer, an organ model, and a testing cell. The “material to which liquid can adhere” includes any material to which liquid can adhere, unless particularly limited.

Examples of the “material to which liquid can adhere” include any materials to which liquid can adhere even temporarily, such as paper, thread, fiber, fabric, leather, metal, plastic, glass, wood, and ceramics.

The “liquid discharge apparatus” may be an apparatus that causes relative movement of the liquid discharge head and a material to which liquid can adhere. However, the liquid discharge apparatus is not limited to such an apparatus. For example, the liquid discharge apparatus may be a serial head apparatus that moves the liquid discharge head, or may be a line head apparatus that does not move the liquid discharge head.

Examples of the “liquid discharge apparatus” also include a treatment solution application apparatus that discharges a treatment solution onto a sheet so as to apply the treatment solution to the surface of the sheet for the purpose of modifying the surface of the sheet. As another example of the “liquid discharge apparatus”, there is also an injection granulation apparatus that jets a composition liquid in which a raw material is dispersed in a solution, through a nozzle to granulate fine particles of the raw material.

The terms “image formation”, “recording”, “printing”, “image printing”, and “fabricating” used herein may be used synonymously with each other.

Although the example in which the actuator of the present embodiment is applied to the liquid discharge head has been described above, the actuator of the present embodiment can also be applied to, for example, the micropumps described in Japanese Unexamined Patent Application Publication No. 2012-253087 and Japanese Unexamined Patent Application Publication No. 2014-030008.

The above-described embodiment shows limited examples, and the present disclosure includes, for example, the following aspects having advantageous effects.

### [Aspect 1]

In the actuator 110 including: the vibrating film 103 formed as a layer on a substrate such as the channel substrate 100 in which a pressure chamber such as the pressure chamber 4 is formed, the vibrating film 103 forming part of a wall surface of the pressure chamber; the piezoelectric element 5 mounted on a surface of the vibrating film 103 opposite to a surface of the vibrating film 103 forming the wall surface of the pressure chamber; the lead wires 9a and 9b that are led out from the piezoelectric element 5, and supply electric power to the piezoelectric element 5; and the moisture-proof film 11 covering the lead wires 9a and 9b, the piezoelectric element 5 is just partially covered with the moisture-proof film 11.

In general, a moisture-proof film formed of a material such as silicon nitride is a dense and hard film. Thus, when the entire surface of the piezoelectric element is covered with the moisture-proof film, there is a possibility that vibration displacement of the piezoelectric element may decrease.

In contrast, in the first aspect, since the moisture-proof film covers only the lead wires and part of the piezoelectric element, it is possible to prevent a decrease in the vibration displacement of the piezoelectric element as compared with a case where the entire piezoelectric element is covered with the moisture-proof film.

### [Aspect 2]

In aspect 1, the piezoelectric element 5 is covered with the moisture-proof film 11 only in the peripheries of the lead wires 9a and 9b and the peripheries of portions, such as the contacts 7d and 7e, where the piezoelectric element 5 is connected to the lead wires 9a and 9b.

According to this aspect, it is possible to minimize the area of the piezoelectric element 5 covered with the moisture-proof film 11, and prevent vibration displacement of the piezoelectric element 5 from being reduced by the moisture-proof film 11, as described with reference to FIG. 4.

### [Aspect 3]

In aspect 1, the piezoelectric element 5 includes: the first electrode 51 formed as a layer on the surface of the vibrating film 103 opposite to the surface of the vibrating film 103 forming the wall surface of the pressure chamber such as the pressure chamber; a piezoelectric portion, such as the piezoelectric film 52, formed as a layer on the first electrode 51; and the second electrode 53 formed as a layer on the piezoelectric portion, and at least the second electrode 53 is just partially covered with the moisture-proof film 11.

According to this aspect, in the piezoelectric element 5, the portion of the first electrode 51 with no piezoelectric portion, such as the piezoelectric film 52, formed as a layer thereon and the portion of the piezoelectric portion with no second electrode 53 formed as a layer thereon are hardly displaced at the time of driving, as described with reference to FIG. 5. Therefore, even when only the second electrode 53 is partially covered with the moisture-proof film 11, a decrease in the vibration displacement of the piezoelectric element 5 can be prevented, and the vibrating film 103 can be satisfactorily vibrated.

### [Aspect 4]

In any one of aspects 1 to 3, at least the vibration region 103a of the vibrating film 103 is covered with the moisture-proof film 11 only in the peripheries of the lead wires 9a and 9b, the vibration region 103a being vibrated by the piezoelectric element 5.

According to this aspect, the Young's modulus of the vibration region 103a can be reduced as compared with a configuration in which the entire vibration region 103a is covered with the moisture-proof film 11, as described with reference to FIG. 6. As a result, the vibration region 103a can be easily vibrated by displacement of the piezoelectric element 5. Thus, vibration efficiency can be enhanced as compared with the configuration in which the entire vibration region 103a is covered with the moisture-proof film 11.

### [Aspect 5]

In any one of aspects 1 to 4, the moisture-proof film 11 includes a nitride of silicon (Si) or an oxide of any of metals of tantalum (Ta), niobium (Nb), titanium (Ti), hafnium (Hf), zirconium (Zr), and tungsten (W).

According to this aspect, good moisture barrier properties can be obtained.

### [Aspect 6]

In a liquid discharge head including the actuator 110 by means of which liquid in a pressure chamber such as the pressure chamber 4 is discharged from the nozzle 2, the actuator according to any one of aspects 1 to 5 is used as the actuator 110.

According to this aspect, liquid can be satisfactorily discharged from the nozzle 2.

### [Aspect 7]

In aspect 6, the nozzle is provided in the actuator 110.

According to this aspect, droplets can be discharged with a smaller force than in a general unimorph piezoelectric head (a liquid discharge head that vibrates a surface of a pressure chamber facing a surface having a nozzle, to discharge liquid) as described in the embodiment. Thus, power saving of the piezoelectric element 5 can be achieved. In addition, the volume of the pressure chamber can be reduced, so that the head can be reduced in size. Furthermore, choices of the piezoelectric element 5 can be increased as compared with the general unimorph piezoelectric head described above. As a result, nozzle density can be easily increased.

### [Aspect 8]

In a liquid discharge device including at least one of a head tank, a carriage, a supply unit, a maintenance unit, or a main scan moving unit; and a liquid discharge head, the liquid discharge head according to aspect 6 or 7 is used as the liquid discharge head.

According to this aspect, liquid can be satisfactorily discharged from the nozzle 2.

### [Aspect 9]

A liquid discharge apparatus includes the liquid discharge head according to aspect 6 or 7, or the liquid discharge device according to aspect 8.

According to this aspect, liquid can be satisfactorily discharged from the nozzle 2.

### [Aspect 10]

A method for manufacturing an actuator, the method including: a step of forming the vibrating film 103 as a layer on the channel substrate 100; a step of forming the piezoelectric element 5 on the vibrating film 103; a step of forming, on the vibrating film 103, the lead wires 9a and 9b that supply electric power to the piezoelectric element 5; and a step of forming the moisture-proof film 11 on the lead wires 9a and 9b and part of the piezoelectric element 5.

According to this aspect, it is possible to manufacture an actuator in which a decrease in the vibration displacement of the piezoelectric element 5 is prevented as compared with a case where the entire piezoelectric element 5 is covered with the moisture-proof film 11.

### [Aspect 11]

An actuator includes: a diaphragm on a substrate having a pressure chamber, the diaphragm having a first surface defining a part of a wall of the pressure chamber; a piezoelectric element on a second surface of the diaphragm opposite to the first surface; a lead wire led out from the piezoelectric element to supply electric power to the piezoelectric element; and a moisture-proof film covering: the lead wire; and a part of the piezoelectric element overlapped with the lead wire.

### [Aspect 12]

In the actuator according to aspect 11, a moisture-proof film covers: the lead wire; the part of the piezoelectric element; a periphery of the lead wire; and a periphery of a connecting portion connecting the piezoelectric element to the lead wire.

### [Aspect 13]

In the actuator according to aspect 2, the piezoelectric element includes: a first electrode on the second surface of the diaphragm; a piezoelectric portion on the first electrode; and a second electrode on the piezoelectric portion, the connection portion includes: a first contact on the first electrode; and a second contact on the second electrode, the lead wire includes: a first lead wire electrically connected to the first contact of the first electrode; and a second lead wire electrically connected to the second contact of the second electrode, and the moisture-proof film covers: the first contact; the second contact; the first lead wire; the second lead wire; and the part of the piezoelectric element in a periphery of the first contact, the second contact, the first lead wire, and the second lead wire.

### [Aspect 14]

In the actuator according to aspect 1, the diaphragm has a vibration region vibrated by the piezoelectric element, and the moisture-proof film covers a part of the vibration region in the periphery of the lead wire.

### [Aspect 15]

In the actuator according to aspect 1, the moisture-proof film includes a nitride of silicon (Si) or an oxide of any of metals of tantalum (Ta), niobium (Nb), titanium (Ti), hafnium (Hf), zirconium (Zr), or tungsten (W).

### [Aspect 16]

A liquid discharge head includes: the actuator according to aspect 3; the substrate having the pressure chamber; and a nozzle communicating with the pressure chamber, wherein the actuator causes a liquid in the pressure chamber to be discharged from the nozzle.

### [Aspect 17]

In the liquid discharge head according to aspect 16, the diaphragm has a vibration region vibrated by the piezoelectric element, and the moisture-proof film annularly covers, except for the vibration region, a region between the first contact and the second contact in a region in which the piezoelectric element is annular around the nozzle.

### [Aspect 18]

In the liquid discharge head according to aspect 17, the moisture-proof film further covers a part of the vibration region in the periphery of the first contact, the second contact, the first lead wire, and the second lead wire.

### [Aspect 19]

In the liquid discharge head according to aspect 6, the actuator has the nozzle penetrating through the diaphragm.

### [Aspect 20]

A liquid discharge apparatus includes: the liquid discharge head according to aspect 16; and at least one of: a head tank to supply the liquid to the liquid discharge head; a carriage mounting the liquid discharge head; a supply unit to supply the liquid to the head tank; a maintenance unit to maintain the liquid discharge head; or a main scan moving unit to move the carriage.

### [Aspect 21]

A method for manufacturing an actuator, the method includes: forming a diaphragm on a substrate; forming a piezoelectric element on the diaphragm; forming a lead wire on the diaphragm, the lead wire to supply electric power to the piezoelectric element; and forming a moisture-proof film on the lead wire and a part of the piezoelectric element.

The above-described embodiments are illustrative and do not limit the present invention.

Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2022-117508, filed on Jul. 22, 2022, in the Japan Patent Office, the entire disclosure of which is hereby incorporated by reference herein.

### REFERENCE SIGNS LIST

1: Liquid discharge head
2: Nozzle
3: Common chamber
4: Pressure chamber
5: Piezoelectric element
6: Electrical connection pad
7a: First contact
7b: Second contact
7c: Third contact
7d: Fourth contact
7e: Fifth contact
8: Insulating film
9a: First lead wire
9b: Second lead wire
10: Pad opening
11: Moisture-proof film
51: First electrode
52: Piezoelectric film
53: Second electrode
100: Channel substrate
101: Drive circuit
102: Wiring portion
103: Vibrating film
103a: Vibration region
103b: Nozzle forming hole
110: Actuator
111: Nozzle forming portion
120: Frame member
403: Carriage
405: Main scan motor
406: Drive pulley
407: Driven pulley
408: Timing belt
440: Liquid discharge device
441: Head tank
493: Main scan moving unit
500: Printer
505: Printing unit
550: Head device

1. An actuator comprising:
a diaphragm on a substrate having a pressure chamber, the diaphragm having a first surface defining a part of a wall of the pressure chamber;
a piezoelectric element on a second surface of the diaphragm opposite to the first surface;
a lead wire led out from the piezoelectric element to supply electric power to the piezoelectric element; and
a moisture-proof film covering:
the lead wire; and
a part of the piezoelectric element overlapped with the lead wire.

2. The actuator according to claim 1, wherein:
the moisture-proof film further covers:
a periphery of the lead wire; and
a periphery of a connecting portion connecting the piezoelectric element to the lead wire.

3. The actuator according to claim 2, wherein:
the piezoelectric element includes:
a first electrode on the second surface of the diaphragm;
a piezoelectric portion on the first electrode; and
a second electrode on the piezoelectric portion,
the connection portion includes:
a first contact on the first electrode; and
a second contact on the second electrode,
the lead wire includes:
a first lead wire electrically connected to the first contact of the first electrode; and
a second lead wire electrically connected to the second contact of the second electrode, and
the moisture-proof film covers:
the first contact;
the second contact;
the first lead wire;
the second lead wire; and
the part of the piezoelectric element which is in a periphery of the first contact, the second contact, the first lead wire, and the second lead wire.

4. The actuator according to claim 1, wherein:
the diaphragm has a vibration region vibrated by the piezoelectric element, and
the moisture-proof film covers a part of the vibration region in a periphery of the lead wire.

5. The actuator according to claim 1, wherein:
the moisture-proof film includes a nitride of silicon (Si) or an oxide of any of metals of tantalum (Ta), niobium (Nb), titanium (Ti), hafnium (Hf), zirconium (Zr), or tungsten (W).

6. A liquid discharge head comprising:
the actuator according to claim 3;
the substrate having the pressure chamber; and
a nozzle communicating with the pressure chamber,
wherein the actuator causes a liquid in the pressure chamber to be discharged from the nozzle.

7. The liquid discharge head according to claim 6, wherein:
the diaphragm has a vibration region vibrated by the piezoelectric element, and
the moisture-proof film annularly covers, except for the vibration region, a region between the first contact and the second contact in a region in which the piezoelectric element is annular around the nozzle.

8. The liquid discharge head according to claim 7, wherein:
the moisture-proof film further covers a part of the vibration region in the periphery of the first contact, the second contact, the first lead wire, and the second lead wire.

9. The liquid discharge head according to claim 6, wherein:
the actuator has the nozzle penetrating through the diaphragm.

10. A liquid discharge apparatus comprising:
the liquid discharge head according to claim 6; and
at least one of:
a head tank to supply the liquid to the liquid discharge head;
a carriage mounting the liquid discharge head;
a supply unit to supply the liquid to the head tank;
a maintenance unit to maintain the liquid discharge head; or
a main scan moving unit to move the carriage.

11. A method for manufacturing an actuator, the method comprising:
forming a diaphragm on a substrate;
forming a piezoelectric element on the diaphragm;
forming a lead wire on the diaphragm, the lead wire to supply electric power to the piezoelectric element; and
forming a moisture-proof film on the lead wire and a part of the piezoelectric element.
